(19) United States
(12) Patent Application Publication
(10) Pub. No.: US 2022/0217265 A1
(43) Pub. Date: Jul. 7, 2022

(54) AUTOMATIC CONTROL OF IMAGE CAPTURE DEVICE DISPLAY OPERATION

(71) Applicant: GoPro, Inc., San Mateo, CA (US)

(72) Inventor: Vincent Vacquerie, Paris (FR)

(21) Appl. No.: 16/946,489

(22) Filed: Jun. 24, 2020

(51) Int. Cl. H04N 5/232; G06K 9/00; G06T 7/70; G06F 3/14; G06T 7/536

(52) U.S. Cl. CPC H04N 5/23219; G06K 9/00255; G06T 7/70; G06T 2207/10016; H04N 5/23293; G06T 7/536; G06T 2207/30201; G06F 3/1423

(57) ABSTRACT

An image capture device may capture visual content through a front-facing optical element. The image capture device may determine whether a face is located within a field of view of the front-facing optical element. Responsive to the face being located within the field of view, preview of the visual content on a front-facing display may be activated. Responsive to the face not being located within the field of view, the preview of the visual content on the front-facing display may be deactivated.

### FIELD

This disclosure relates to automatically controlling operation of a display of an image capture device based on face detection.

### BACKGROUND

An image capture device may include one or more displays to present information, such as preview of visual content being captured by the image capture device. Operation of the display(s) may consume resources of the image capture device, such as battery power and/or processing power. The resource(s) of the image capture device may be wasted if no one is looking at the display(s).

### SUMMARY

This disclosure relates to automatic control of display operation. An image capture device may include a housing. The housing may have multiple sides. The housing may carry one or more of an image sensor, an optical element, a display, and/or other components. The optical element may be carried on a first side of the housing. The optical element may guide light within a field of view to the image sensor. The image sensor may generate a visual output signal conveying visual information defining visual content based on light that becomes incident thereon. The display may be carried on the first side of the housing.

The visual content may be captured through the optical element during a capture duration. Whether a face is located within a target field of view of the optical element during the capture duration may be determined based on analysis of the visual content and/or other information. Responsive to the face being located within the target field of view of the optical element and the display not presenting a preview of the visual content, presentation of the preview of the visual content on the display may be activated. Responsive to the face not being located within the target field of view of the optical element and the display presenting the preview of the visual content, the presentation of the preview of the visual content on the display may be deactivated.

An electronic storage may store visual information defining visual content, information relating to visual content, information relating to optical element, information relating to the field of view of the optical element, information relating to target field of view, information relating to face, information relating to display, and/or other information.

The housing may have multiple sides. The housing carry one or more components of the image capture device. The housing may carry (be attached to, support, hold, and/or otherwise carry) one or more of an image sensor, an optical element, a display, a processor, an electronic storage, and/or other components. The optical element and the display may be carried on the same side of the housing. The optical element and the display may be carried on a first side of the housing. In some implementations, the housing may carry multiple display. In some implementations, the housing may carry multiple image sensors and multiple optical elements.

The image sensor may be configured to generate a visual output signal and/or other output signals. The visual output signal may convey visual information based on light that becomes incident thereon and/or other information. The visual information may define visual content.

The optical element may be configured to guide light within a field of view to the image sensor. The field of view may be less than 180 degrees. The field of view may be equal to 180 degrees. The field of view may be greater than 180 degrees.

The processor(s) may be configured by machine-readable instructions. Executing the machine-readable instructions may cause the processor(s) to facilitate automatic control of display operation. The machine-readable instructions may include one or more computer program components. The computer program components may include one or more of a capture component, a face component, a display component, and/or other computer program components.

The capture component may be configured to capture the visual content during one or more capture durations. The visual content may be captured through the optical element.

The face component may be configured to determine whether a face is located within a target field of view of the optical element during the capture duration(s). Whether the face is located within the target field of view of the optical element may be determined based on analysis of the visual content and/or other information. In some implementations, the analysis of the visual content may include analysis of a target portion of the visual content.

In some implementations, the face component may be configured to determine whether the face is located within a target distance of the optical element during the capture duration(s). In some implementations, a distance between the face and the optical element may be determined based on size of the face within the visual content and/or other information.

In some implementations, the target distance may be determined based on location of the face within the target field of view and/or other information. In some implementations, the target distance may be farther for the location of the face closer to center of the target field of view.

The display component may be configured to control operation of the display. The display component may be configured to activate presentation of a preview of the visual content on the display. The presentation of the preview of the visual content on the display may be activated responsive to the face being located within the target field of view of the optical element, the display not presenting the preview of the visual content, and/or other information. The display component may be configured to deactivate the presentation of the preview of the visual content on the display. The presentation of the preview of the visual content on the display may be deactivated responsive to the face not being located within the target field of view of the optical element, the display presenting the preview of the visual content, and/or other information.

In some implementations, the presentation of the preview of the visual content on the display may be conditioned on the face being located with the target distance of the optical element and/or other information.

In some implementations, another display may be carried on a second side of the housing. In some implementations, the first side of the housing may be opposite of the second side of the housing. In some implementations, the display on the first side of the housing may include a front display and the other display on the second side of the housing may include a rear display. In some implementations, the other display on the second side of the housing may be deactivated during the presentation of the preview of the visual content on the display on the first side of the housing. In some implementations, the other display on the second side of the housing may be activated during non-presentation of the preview of the visual content on the display on the first side of the housing.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system that automatically controls display operation.

FIG. 2 illustrates an example method for automatically controlling display operation.

FIGS. 3A and 3B illustrate example image capture devices.

FIG. 4 illustrates example field of view and target field of view.

FIGS. 5A and 5B illustrate examples of faces depicted within visual content.

### DETAILED DESCRIPTION

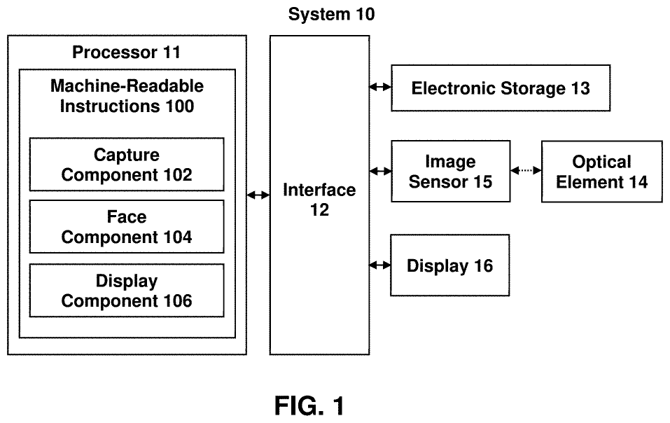

FIG. 1 illustrates a system 10 for automatically controlling display operation. The system 10 may include one or more of a processor 11, an interface 12 (e.g., bus, wireless interface), an electronic storage 13, an optical element 14, an image sensor 15, a display 16, and/or other components. The system 10 may include and/or be part of an image capture device. The image capture device may include a housing having multiple sides, and one or more of the optical element 14, the image sensor 15, the display 16, and/or other components of the system 10 may be carried by the housing of the image capture device. The optical element 14 and the display 16 may be carried on the same side of the housing. The optical element 14 may guide light within a field of view to the image sensor 15. The image sensor 15 may generate a visual output signal conveying visual information defining visual content based on light that becomes incident thereon.

The processor 11 may capture the visual content through the optical element 14 during a capture duration. Whether a face is located within a target field of view of the optical element 14 during the capture duration may be determined by the processor 11 based on analysis of the visual content and/or other information. Responsive to the face being located within the target field of view of the optical element 14 and the display 16 not presenting a preview of the visual content, presentation of the preview of the visual content on the display 16 may be activated by the processor 11. Responsive to the face not being located within the target field of view of the optical element 14 and the display 16 presenting the preview of the visual content, the presentation of the preview of the visual content on the display 16 may be deactivated by the processor 11.

The electronic storage 13 may be configured to include electronic storage medium that electronically stores information. The electronic storage 13 may store software algorithms, information determined by the processor 11, information received remotely, and/or other information that enables the system 10 to function properly. For example, the electronic storage 13 may store visual information defining visual content, information relating to visual content, information relating to optical element, information relating to the field of view of the optical element, information relating to target field of view, information relating to face, information relating to display, and/or other information.

Visual content may refer to content of image(s), video frame(s), and/or video(s) that may be consumed visually. For example, visual content may be included within one or more images and/or one or more video frames of a video. The video frame(s) may define/contain the visual content of the video. That is, video may include video frame(s) that define/contain the visual content of the video. Video frame(s) may define/contain visual content viewable as a function of progress through the progress length of the video content. A video frame may include an image of the video content at a moment within the progress length of the video. As used herein, term video frame may be used to refer to one or more of an image frame, frame of pixels, encoded frame (e.g., I-frame, P-frame, B-frame), and/or other types of video frame. Visual content may be generated based on light received within a field of view of a single image sensor or within fields of view of multiple image sensors.

Visual content (of image(s), of video frame(s), of video(s)) with a field of view may be captured by an image capture device during a capture duration. A field of view of visual content may define a field of view of a scene captured within the visual content. A capture duration may be measured/defined in terms of time durations and/or frame numbers. For example, visual content may be captured during a capture duration of 60 seconds, and/or from one point in time to another point in time. As another example, 1800 images may be captured during a capture duration. If the images are captured at 30 images/second, then the capture duration may correspond to 60 seconds. Other capture durations are contemplated.

Visual content may be stored in one or more formats and/or one or more containers. A format may refer to one or more ways in which the information defining visual content is arranged/laid out (e.g., file format). A container may refer to one or more ways in which information defining visual content is arranged/laid out in association with other information (e.g., wrapper format). Information defining visual content (visual information) may be stored within a single file or multiple files. For example, visual information defining an image or video frames of a video may be stored within a single file (e.g., image file, video file), multiple files (e.g., multiple image files, multiple video files), a combination of different files, and/or other files.

The system 10 may be remote from the image capture device or local to the image capture device. One or more portions of the image capture device may be remote from or a part of the system 10. One or more portions of the system 10 may be remote from or a part of the image capture device. For example, one or more components of the system 10 may be carried by a housing, such as a housing of an image capture device. For instance, the optical element 14, the image sensor 15, and/or the display 16 of the system 10 may be carried by the housing of the image capture device.

An image capture device may refer to a device captures visual content. An image capture device may capture visual content in form of images, videos, and/or other forms. An image capture device may refer to a device for recording visual information in the form of images, videos, and/or other media. An image capture device may be a standalone device (e.g., camera, action camera, image sensor) or may be part of another device (e.g., part of a smartphone, tablet).

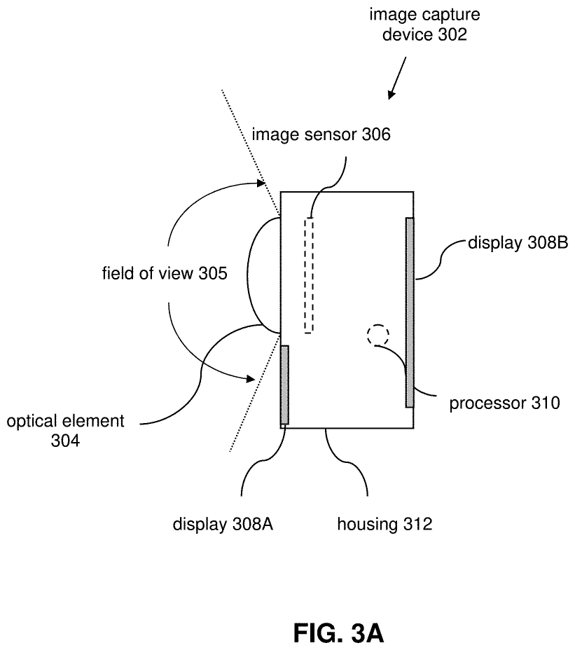

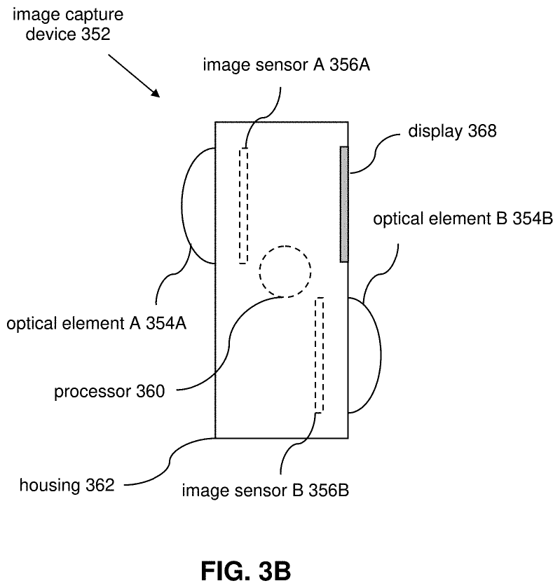

FIG. 3A illustrates an example image capture device 302. Visual content (e.g., of image(s), video frame(s)) may be captured by the image capture device 302. The image capture device 302 may include a housing 312. The housing 312 may refer a device (e.g., casing, shell) that covers, protects, and/or supports one or more components of the image capture device 302. The housing 312 may include a single-piece housing or a multi-piece housing. The housing 312 carry one or more components of the image capture device 302. The housing 312 may carry (be attached to, support, hold, and/or otherwise carry) one or more of an optical element 304, an image sensor 306, a display 308A, a display 308B, a processor 310, and/or other components.

The optical element 304 and the display 308A may be carried on the same side of the housing. For example, the optical element 304 and the display 308A may be carried on a front side of the housing 312. The display 308A may be a front-facing display of the image capture device 302. In some implementations, the housing 312 may carry multiple displays, such as shown in FIG. 3A. The display 308B may be carried on a rear side of the housing 312. The display 308B may be a rear-facing display of the image capture device 302.

In some implementations, the housing may carry multiple image sensors and multiple optical elements. FIG. 3B illustrates an example image capture device 352. Visual content (e.g., of spherical image(s), spherical video frame(s)) may be captured by the image capture device 352. The image capture device 352 may include a housing 362. The housing 362 carry one or more components of the image capture device 352. The housing 362 may carry one or more of an optical element A 354A, an optical element B 354B, an image sensor A 356A, an image sensor B 356B, a display 368, a processor 360, and/or other components.

One or more components of the image capture device may be the same as, be similar to, and/or correspond to one or more components of the system 10. For example, referring to FIG. 3A, the processor 310 may be the same as, be similar to, and/or correspond to the processor 11. The optical element 304 may be the same as, be similar to, and/or correspond to the optical element 14. The image sensor 306 may be the same as, be similar to, and/or correspond to the image sensor 15. The display 308A may be the same as, be similar to, and/or correspond to the display 16. The housing may carry other components, such as the electronic storage 13. The image capture device may include other components not shown in FIGS. 3A and 3B. The image capture device may not include one or more components shown in FIGS. 3A and 3B. Other configurations of image capture devices are contemplated.

An optical element may include instrument(s), tool(s), and/or medium that acts upon light passing through the instrument(s)/tool(s)/medium. For example, an optical element may include one or more of lens, mirror, prism, and/or other optical elements. An optical element may affect direction, deviation, and/or path of the light passing through the optical element. An optical element may have a field of view (e.g., field of view 305 shown in FIG. 3A). The optical element may be configured to guide light within the field of view (e.g., the field of view 305) to an image sensor (e.g., the image sensor 306).

The field of view may include the field of view of a scene that is within the field of view of the optical element and/or the field of view of the scene that is delivered to the image sensor. For example, referring to FIG. 3A, the optical element 304 may guide light within its field of view to the image sensor 306 or may guide light within a portion of its field of view to the image sensor 306. The field of view of 305 of the optical element 304 may refer to the extent of the observable world that is seen through the optical element 304. The field of view 305 of the optical element 304 may include one or more angles (e.g., vertical angle, horizontal angle, diagonal angle) at which light is received and passed on by the optical element 304 to the image sensor 306. In some implementations, the field of view 305 may be greater than 180-degrees. In some implementations, the field of view 305 may be less than 180-degrees. In some implementations, the field of view 305 may be equal to 180-degrees.

In some implementations, the image capture device may include multiple optical elements. The image capture device may include multiple optical elements that are arranged on the housing to capture spherical images/videos (guide light within spherical field of view to one or more images sensors). For instance, referring to FIG. 3B, the image capture device 352 may include two optical elements 354A, 354B positioned on opposing sides of the housing 362. The fields of views of the optical elements 354A, 354B may overlap and enable capture of spherical images and/or spherical videos.

An image sensor may include sensor(s) that converts received light into output signals. The output signals may include electrical signals. The image sensor may generate output signals conveying visual information that defines visual content of one or more images and/or one or more video frames of a video. For example, the image sensor may include one or more of a charge-coupled device sensor, an active pixel sensor, a complementary metal-oxide semiconductor sensor, an N-type metal-oxide-semiconductor sensor, and/or other image sensors.

The image sensor may be configured generate output signals conveying information that defines visual content of one or more images and/or one or more video frames of a video. The image sensor may be configured to generate a visual output signal based on light that becomes incident thereon during a capture duration and/or other information. The visual output signal may convey visual information that defines visual content having the field of view. For example, referring to FIG. 3A, the optical element 304 may be configured to guide light within the field of view 305 to the image sensor 306, and the image sensor 306 may be configured to generate visual output signals conveying visual information based on light that becomes incident thereon via the optical element 304.

The visual information may define visual content by including information that defines one or more content, qualities, attributes, features, and/or other aspects of the visual content. For example, the visual information may define visual content of an image by including information that makes up the content of the image, and/or information that is used to determine the content of the image. For instance, the visual information may include information that makes up and/or is used to determine the arrangement of pixels, characteristics of pixels, values of pixels, and/or other aspects of pixels that define visual content of the image. For example, the visual information may include information that makes up and/or is used to determine pixels of the image. Other types of visual information are contemplated.

Capture of visual content by the image sensor may include conversion of light received by the image sensor into output signals/visual information defining visual content. Capturing visual content may include recording, storing, and/or otherwise capturing the visual content for use in previewing and/or generating video content (e.g., content of video frames). For example, during a capture duration, the visual output signal generated by the image sensor 306 and/or the visual information conveyed by the visual output signal may be used to record, store, and/or otherwise capture the visual content for use in previewing and/or generating video content.

In some implementations, the image capture device may include multiple image sensors. For example, the image capture device may include multiple image sensors carried by the housing to capture spherical images/videos based on light guided thereto by multiple optical elements. For instance, referring to FIG. 3B, the image capture device 362 may include two image sensors 356A, 356B configured to receive light from two optical elements 354A, 354B positioned on opposing sides of the housing 362.

A display may refer to an electronic device that provides visual presentation of information. A display may include a color display and/or a non-color display. In some implementations, a display may include one or more touchscreen displays. A display may be configured to visually present information. A display may be configured to present visual content, user interface, and/or other information. User interface (graphical user interface) may include a graphical form that enables a user to interact with the image capture device and/or see information provided by the image capture device. For example, referring to FIG. 3A, the display 308A and/or the display 308B may present preview of visual content being captured by the image capture device 302 (e.g., preview of visual content before and/or during recording), visual content that has been captured by the image capture device 302, setting information of the image capture device 302 (e.g., resolution, framerate, mode), and/or other information for the image capture device 302.

The display 308A (front-facing display) may enable a user to see visual content being captured by the image capture device 302, the user interface, the user interface elements, and/or other information while the image capture device 302 is pointed towards the user, such as when the user is in front of the image capture device 302. The display 308B (rear-facing display) may enable a user to see visual content being captured by the image capture device 302, the user interface, the user interface elements, and/or other information while the image capture device 302 is pointed away from the user, such as when the user is behind the image capture device 302.

A processor may include one or more processors (logic circuitry) that provide information processing capabilities in the image capture device. The processor may provide one or more computing functions for the image capture device. The processor may operate/send command signals to one or more components of the image capture device to operate the image capture device. For example, referring to FIG. 3A, the processor 310 may facilitate operation of the image capture device 302 in capturing image(s) and/or video(s), facilitate operation of the optical element 304 (e.g., change how light is guided by the optical element 304), and/or facilitate operation of the image sensor 306 (e.g., change how the received light is converted into information that defines images/videos and/or how the images/videos are post-processed after capture).

The processor 310 may obtain information from the image sensor 306 and/or facilitate transfer of information from the image sensor 306 to another device/component. The processor 310 may be remote from the processor 11 or local to the processor 11. One or more portions of the processor 310 may be remote from the processor 11 and/or one or more portions of the processor 10 may be part of the processor 310. The processor 310 may include and/or perform one or more functionalities of the processor 11 shown in FIG. 1.

An image capture device may automatically control operation of one or more displays. The operation of the display(s) may be automatically controlled based on face detection so that information is presented on the display(s) when a face is detected within a target field of view of the optical element(s) on the same side as the display(s), and so that information is not presented on the display(s) when a face is not detected within the target field of view of the optical element(s) on the same side as the display(s).

For example, referring to FIG. 3A, the image capture device 302 may capture visual content through the optical element 304 during a capture duration. The image capture device 302 may determine whether a face is located within a target field of view of the optical element 304 during the capture duration based on analysis of the visual content. The image capture device 302 may operate the display 308A based on whether or not a face is located within the target field of view of the optical element 304 during the capture duration. Responsive to a face being located within the target field of view of the optical element 304 and the display 308A not presenting information (e.g., preview of the visual content), presentation of the information on the display 308A may be activated. Responsive to a face not being located within the target field of view of the optical element 304 and the display 308A presenting information (e.g., preview of the visual content), the presentation of the information on the display 308A may be deactivated.

Referring to FIG. 3B, the image capture device 352 may capture visual content through the optical element 354B during a capture duration. The image capture device 352 may determine whether a face is located within a target field of view of the optical element 354B during the capture duration based on analysis of the visual content. The image capture device 352 may operate the display 368 based on whether or not a face is located within the target field of view of the optical element 354B during the capture duration. Responsive to a face being located within the target field of view of the optical element 354B and the display 368 not presenting information (e.g., preview of the visual content), presentation of the information on the display 368 may be activated. Responsive to a face not being located within the target field of view of the optical element 354B and the display 368 presenting information (e.g., preview of the visual content), the presentation of the information on the display 368 may be deactivated.

In some implementations, the image capture device 352 may include multiple display, such as a front-facing display on the same side as the optical element A 354A and a rear-facing display on the same-side as the optical element B 354B. The image capture device 352 may automatically control operation of the multiple displays based on face detection so that the front-facing display presents information based on a face being detected within a target field of view of the optical element A 354A and so that the rear-facing display presents information based on a face being detected within a target field of view of the optical element B 354B. Presentation of information on the displays may be deactivated based on face not being detected within the target field of view of the optical element on the side. Thus, the image capture device 352 may automatically switch between presentation of information on front/rear display based on detection of face within target field of view of front/rear facing optical element.

Referring back to FIG. 1, the processor 11 (or one or more components of the processor 11) may be configured to obtain information to facilitate automatic control of display operation. Obtaining information may include one or more of accessing, acquiring, analyzing, determining, examining, identifying, loading, locating, opening, receiving, retrieving, reviewing, selecting, storing, and/or otherwise obtaining the information. The processor 11 may obtain information from one or more locations. For example, the processor 11 may obtain information from a storage location, such as the electronic storage 13, electronic storage of information and/or signals generated by one or more sensors, electronic storage of a device accessible via a network, and/or other locations. The processor 11 may obtain information from one or more hardware components (e.g., an image sensor) and/or one or more software components (e.g., software running on a computing device).

The processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate automatic control of display operation. The machine-readable instructions 100 may include one or more computer program components. The machine-readable instructions 100 may include one or more of a capture component 102, a face component 104, a display component 106, and/or other computer program components.

The capture component 102 may be configured to capture the visual content during one or more capture durations. A capture duration may refer to a time duration in which visual content is captured. The visual content may be captured through one or more optical elements (e.g., the optical element 14). For example, referring to FIG. 3A, the visual content may be captured through the optical element 304. Referring to FIG. 3B, the visual content may be captured through the optical element A 304A and/or the optical element B 304B.

Capturing visual content during a capture duration may include using, recording, storing, and/or otherwise capturing the visual content during the capture duration. For instance, visual content may be captured while the image capture device is operating in a record mode (e.g., video recording mode) and/or operating in a preview mode (e.g., showing preview of visual content to be captured on a display). The visual content may be captured for use in generating images and/or video frames. The images/video frames may be stored in electronic storage and/or deleted after use (e.g., after preview). The visual content may be captured for use in determining whether a face is located within target field(s) of view of the optical element(s).

For example, during a capture duration, the capture component 102 may use the visual output signal generated by the image sensor 15 and/or the visual information conveyed by the visual output signal to record, store, and/or otherwise capture the visual content. For instance, the capture component 102 may store, in the electronic storage 13 and/or other (permanent and/or temporary) electronic storage medium, information (e.g., the visual information) defining the visual content based on the visual output signal generated by the image sensor 15 and/or the visual information conveyed by the visual output signal during the capture duration. In some implementations, information defining the captured visual content may be stored in one or more visual tracks. In some implementations, the information defining the visual content may be discarded. For instance, the visual information defining the visual content may be temporarily stored (e.g., in a buffer) for use in determining whether a face is located within target field(s) of view of the optical element(s), and the visual information may be deleted after the determination.

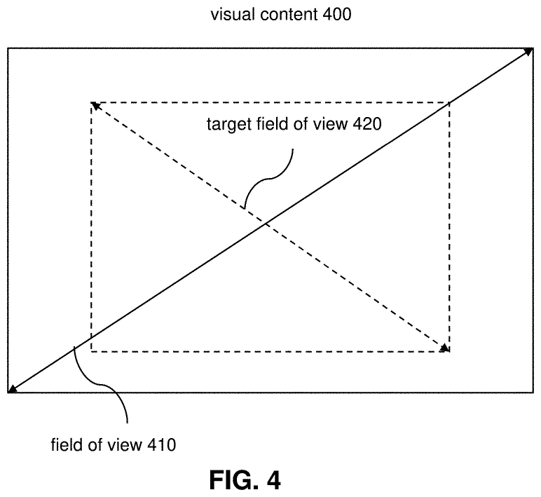

The face component 104 may be configured to determine whether a face is located within target field of view(s) of the optical element(s) during the capture duration(s). A target field of view of an optical element may refer to a portion of the field of view of the optical element within which a face must be located to effectuate certain operations of the display 16. For example, for presentation of information on the display 16 to be activated, a face may be required to be located within a target field of view of the optical element 14. For presentation of information on the display 16 to be deactivated, a face may be required to be not located within the target field of view of the optical element 14. The target field of view of the optical element 14 may be as large as the field of view of the optical element 14. The target field of view of the optical element 14 may be smaller than the field of view of the optical element. FIG. 4 illustrates example field of view 410 and target field of view 420. The target field of view 420 may be smaller than the field of view 410. The target field of view 420 may be centered in the field of view 410. Other sizes of the target field of view and other placement (e.g., non-centered placement) of the target field of view within the field of view of the optical element are contemplated.

Whether a face is located within the target field of view of the optical element 14 may be determined based on analysis of the visual content and/or other information. That is, the visual content captured by the capture component 102 may be analyzed to determine whether a face is located within the target field of view of the optical element 14. Analysis of the visual content may include examination, evaluation, processing, studying, and/or other analysis of the visual content. For example, analysis of the visual content may include examination, evaluation, processing, studying, and/or other analysis of one or more visual features/characteristics of the visual content. Analysis of the visual content may include analysis of visual content of a single image and/or analysis of visual content of multiple images. For example, visual features and/or visual characteristics of a single image may be analyzed to determine whether or not a face is within a target field of view of an optical element. Visual features and/or visual characteristics of multiple images (e.g., captured at different moment, captured over a duration of time) may be analyzed to determine whether or not a face is within a target field of view of an optical element.

One or more face detection techniques may be used to perform the analysis of the visual content. For example, when the image capture device is operating in a record mode or a preview mode, the image sensor 15 may be on/operating to generate a visual output signal conveying visual information based on light conveyed to the image sensor 15 by the optical element 14. Preview images/video frames may be generated to provide preview of the visual content on the display 16. One or more face detection analytics may be used to determine whether or not a face is located within the preview images/video frames.

In some implementations, the face component 104 may be configured to detect faces within a certain distance of the optical element 14. That is, the face component 104 may be configured to determine whether a face is located within the target field of view of the optical element 14 and within a certain distance of the optical element 14. In some implementations, the distance range of the face detection may depend on the field of view of the optical element 14.

Analysis of the visual content may include analysis of entirety of the visual content or one or more portions of the visual content. For example, rather than analyzing the entirety of the visual content, a target portion of the visual content may be analyzed to determine whether a face is located within the target portions of the visual content. The target portion of the visual content may correspond to the target field of view of the optical element 14. The target portion of the visual content may include visual content generated from light conveyed through the target field of view of the optical element 14. Analysis of the target portion of the visual content may decrease the amount of resources (e.g., power, memory, time) required/consumed to determine whether or not a face is within a target field of view of an optical element. In some implementations, a target portion of the visual content may be analyzed based on application of one or more masks to the visual content and/or other information. A mask may refer to an image whose pixel value (e.g., intensity value) is used to select one or more portions of the image (e.g., for analysis). The application of the mask to the visual content may output a target portion of the visual content. For example, the pixels in other portions the visual content may be masked by the mask and the pixels in the target portion of the visual content may be outputted for analysis.

In some implementations, the face component 104 may be configured to determine whether the face is located within target distance(s) of the optical element(s) during the capture duration(s). A target distance of an optical element may refer to a distance from the optical element within which a face must be located to effectuate certain operations of the display 16. For example, for presentation of information on the display 16 to be activated, a face may be required to be located within a target field of view of the optical element 14 and within a target distance of the optical element 14. Requiring the face to be within a target distance (range) of an optical element may enable operation of the display 16 to present information when a person is close enough to the display 16 to view/read the information presented on the display 16. Use of the target distance may enable the image capture device to deactivate presentation of information on the display 16 when a face within the target field of view of the optical element 14 is farther from the optical element 14 than the target distance.

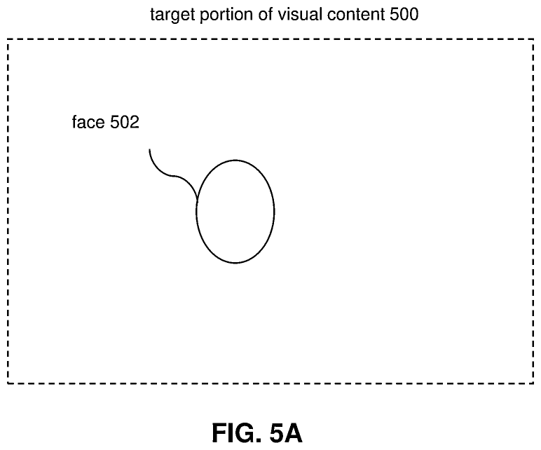

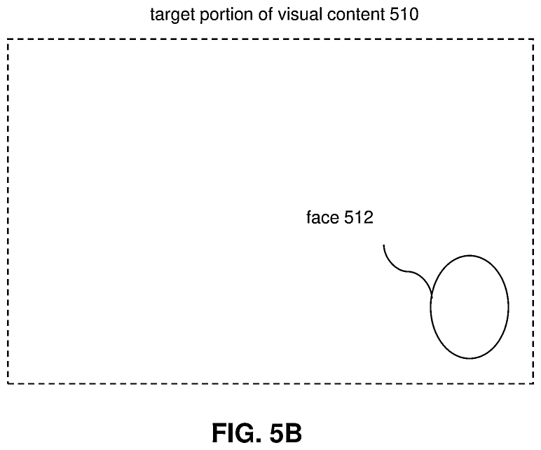

In some implementations, a distance between a face and the optical element 14 may be determined based on one or more range finders and/or one or more proximity sensors. The range finder(s) and/or the proximity sensor(s) may provide information on distance between the optical element 14 and the face within the target field of view of the optical element 14. In some implementations, a distance between a face and the optical element 14 may be determined based on one or more depth maps. Depth maps may provide information distance between the optical element 14 and objects around the optical element 14, such as a person whose face is within the target field of view of the optical element 14. In some implementations, a distance between a face and the optical element 14 may be determined based on size of the face within the visual content and/or other information. A size of the face may refer to the spatial extent/degrees of the visual content taken up by the face. FIG. 5A illustrate an example of a face depicted within visual content. Target portion of visual content 500 may include depiction of a face 502. The size of the face 502 may refer to the spatial extent/degrees of the visual content/target portion of visual content 500 within which the face 502 is depicted. Larger sizes of faces may correspond to closer distances while smaller sizes of faces may correspond to farther distances from the optical element 14. Other determination of distances between a face and the optical element 14 are contemplated.

In some implementations, the target distance may be determined based on location of the face within the target field of view and/or other information. That is, the value of the target distance may change based on where within the target field of view the face is located. some implementations, the target distance may be farther for locations of the face closer to center of the target field of view, and the target distance may be closer for locations of the face farther from the center of the target field of view.

A face that is directly in front of the optical element 14 may be located near the center of the target field of view. A face that is located away from the front of the optical element 14 may be located away from the target field of view. For example, referring to FIG. 5A, the location of the face 502 near the center of the target portion of the visual content 502 may indicate that the person is directly looking at the optical element 14 and the display 16. Such direct line of sight may enable the person to make out information presented on the display 16 from a farther distance than a person who is looking at the display 16 at an angle.

For example, FIG. 5B illustrate another example of a face depicted within visual content. Target portion of visual content 510 may include depiction of a face 512. The face may be located in the bottom right corner, which may indicate that the person is looking at the optical element 14 and the display 16 at an angle. Such angled sight may reduce the visibility of the information presented on the display 16.

The display component 106 may be configured to control operation of one or more displays of the image capture device. Operation of a display may refer to one or more ways in which the display operates. Operation of a display may refer to one or more methods and/or one or more manners of functioning of the display. For example, operation of a display may refer to one or more ways in which a display is turned on, the display is turned off, presentation of information on the display is activated, presentation of information on the display is deactivated, and/or other operation of the display. How the display operates and/or is operated may change based on whether or not a face is located within a target field of view of an optical element. For example, how the display 16 operates and/or is operated may change based on whether or not a face is located within a target field of view of the optical element 14.

The display component 106 may be configured to activation presentation of information on the display 16. For example, the display component 106 may be configured to activate presentation of a preview of the visual content on the display 16, activate presentation of setting of the image capture device on the display 16, and/or activate presentation of other information on the display 16. Activating presentation of information on the display 16 may include turning on the display and/or changing type of information presented on the display. For example, the display 16 may be turned off, and the display component 106 may turn on the display 16 to present preview of visual content being captured by the image capture device. As another example, the display 16 may be turned on and presenting non-preview information (e.g., setting of the image capture device), and the display component 106 may change display operation to present preview of visual content being captured by the image capture device.

The presentation of information (e.g., the preview of the visual content) on the display 16 may be activated responsive to the face being located within the target field of view of the optical element 14, the display 16 not presenting the information (e.g., preview of the visual content), and/or other information. For example, based on the display 16 currently not presenting preview of the visual content (e.g., the display 16 turned off or presenting non-preview information) and a face being detected within the target field of view of the optical element 14 (indicating that a person is looking at the display 16 and/or is positioned to view preview presented on the display 16), the display component 106 may activate presentation of preview of the visual content on the display 16. Thus, the preview of the visual content on the display 16 may be automatically turned on based on face detection indicating that a person is viewing the display 16 and/or the person is in a position to view the display 16.

The display component 106 may be configured to deactivate the presentation of the preview of the visual content on the display 16, deactivate presentation of setting of the image capture device on the display 16, and/or deactivate presentation of other information on the display 16. Deactivating presentation of information on the display 16 may include turning off the display and/or changing type of information presented on the display. For example, the display 16 may be turned on and presenting preview of visual content being captured by the image capture device, and the display component 106 may turn off the display 16 to deactivate presentation of preview on the display 16. As another example, the display 16 may be turned on and presenting preview of visual content being captured by the image capture device, and the display component 106 may change display operation to present setting of the image capture device and/or other information on the display 16.

The presentation of information (e.g., the preview of the visual content) on the display 16 may be deactivated responsive to the face not being located within the target field of view of the optical element 14, the display 16 presenting the information (e.g., preview of the visual content), and/or other information. For example, the display 16 may be presenting preview of visual content based on a face initially being detected within the target field of view of the optical element 14. The person may move and/or the image capture device may be moved so that the face of the person is not detected within the target field of view of the optical element 14 (e.g., indicating that the person is no longer looking at the display 16 and/or is no longer positioned to view preview presented on the display 16), and the display component 106 may deactivate presentation of preview of the visual content on the display 16. Thus, the preview of the visual content on the display 16 may be automatically turned off based on face detection indicating that a person is not viewing the display 16 and/or the person is not in a position to view the display 16.

In some implementations, the presentation of information (e.g., the preview of the visual content) on the display 16 may be conditioned on the face being located with the target distance of the optical element 14 and/or other information. A person may not be able to distinguish information presented on the display 16 after a given distance. Thus, presenting information on the display 16 for a person far away may be wasting resources of the image capture device. The operation of the display 16 may be controlled so that presentation of information (e.g., the preview of the visual content) on the display 16 is activated based on the face being detected (1) within the target field of view of the optical element 14 and (1) within the target distance of the optical element 14. Presentation of information (e.g., the preview of the visual content) on the display 16 is deactivated based on the face not being detected (1) within the target field of view of the optical element 14 or (1) within the target distance of the optical element 14.

In some implementations, the image capture device may include multiple displays, such as shown in FIG. 3A. In FIG. 3A, the display 308A may be a front display and the display 308B may be a rear display. In some implementations, presentation of information may switch between the display 308A, 308B. For example, when presentation of preview of the visual content is activated on the display 308A, presentation of the preview of the visual content on the display 308B may be deactivated. In some implementations, presentation of preview of the visual content on the display 308A may activated further based on analysis of the visual content indicating that the person is using the image capture device to capture selfie image(s)/video(s). When presentation of preview of the visual content is not activated on the display 308A, presentation of the preview of the visual content on the display 308B may be activated. In some implementation, presentation of preview of the visual content on the display 308B may activated further based on sensor reading (e.g., proximity sensor reading) indicating that a person is behind the image capture device 302. Thus, displays 308A, 308B may be operated to switch presentation of information between the displays 308A, 308B.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible (non-transitory) machine-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11 and the electronic storage 13 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11 is shown in FIG. 1 as a single entity, this is for illustrative purposes only. In some implementations, the processor 11 may comprise a plurality of processing units. These processing units may be physically located within the same device, or the processor 11 may represent processing functionality of a plurality of devices operating in coordination. The processor 11 may be configured to execute one or more components by software; hardware; firmware; some combination of software, hardware, and/or firmware; and/or other mechanisms for configuring processing capabilities on the processor 11.

It should be appreciated that although computer components are illustrated in FIG. 1 as being co-located within a single processing unit, in implementations in which processor 11 comprises multiple processing units, one or more of computer program components may be located remotely from the other computer program components.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

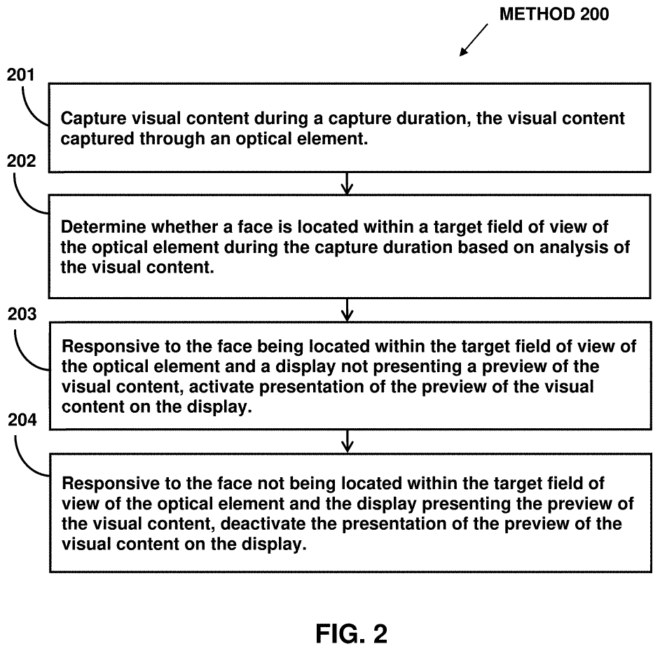

FIG. 2 illustrates method 200 for automatically controlling display operation. The operations of method 200 presented below are intended to be illustrative. In some implementations, method 200 may be accomplished with one or more additional operations not described, and/or without one or more of the operations discussed. In some implementations, two or more of the operations may occur simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operation of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, an image capture device may include a housing. The housing may have multiple sides. The housing may carry one or more of an image sensor, an optical element, a display, and/or other components. The optical element may be carried on a first side of the housing. The optical element may be configured to guide light within a field of view to the image sensor. The image sensor may generate a visual output signal conveying visual information defining visual content based on light that becomes incident thereon. The display may be carried on the first side of the housing.

At operation 201, the visual content may be captured through the optical element during a capture duration. In some implementation, operation 201 may be performed by a processor component the same as or similar to the capture component 102 (Shown in FIG. 1 and described herein).

At operation 202, whether a face is located within a target field of view of the optical element during the capture duration may be determined based on analysis of the visual content and/or other information. In some implementations, operation 202 may be performed by a processor component the same as or similar to the face component 104 (Shown in FIG. 1 and described herein).

At operation 203, responsive to the face being located within the target field of view of the optical element and the display not presenting a preview of the visual content, presentation of the preview of the visual content on the display may be activated. In some implementations, operation 203 may be performed by a processor component the same as or similar to the display component 106 (Shown in FIG. 1 and described herein).

At operation 204, responsive to the face not being located within the target field of view of the optical element and the display presenting the preview of the visual content, the presentation of the preview of the visual content on the display may be deactivated. In some implementations, operation 203 may be performed by a processor component the same as or similar to the display component 106 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

1. An image capture device for automatically controlling display operation, the image capture device comprising:
a housing having multiple sides, the multiple sides including a front side and a rear side;
an image sensor carried by the housing and configured to generate a visual output signal conveying visual information based on light that becomes incident thereon, the visual information defining visual content;
an optical element carried on the front side of the housing, the optical element configured to guide light within a field of view to the image sensor;
a front display carried on the front side of the housing;
a rear display carried on the rear side of the housing; and
one or more physical processors carried by the housing, the one or more physical processors configured by machine-readable instructions to:
capture the visual content during a capture duration, the visual content captured through the optical element;
present a preview of the visual content on the rear display;
determine whether a face is located within a center portion of the field of view of the optical element during the capture duration based on analysis of the visual content, the center portion of the field of view being smaller than the field of view;
responsive to the face being located within the center portion of the field of view of the optical element and the front display not presenting the preview of the visual content, switch the presentation of the preview of the visual content from being presented on the rear display to being presented on the front display; and
responsive to the face not being located within the center portion of the field of view of the optical element and the front display presenting the preview of the visual content, switch the presentation of the preview of the visual content from being presented on the front display to being presented on the rear display.

2. The image capture device of claim 1, wherein the one or more physical processors are further configured by the machine-readable instructions to determine whether the face is located within a target distance of the optical element during the capture duration, further wherein the switch in the presentation of the preview of the visual content from being presented on the rear display to being presented on the front display is conditioned on the face being located with the target distance of the optical element.

3. (canceled)

4. (canceled)

5. The image capture device of claim 2, wherein a distance between the face and the optical element is determined based on size of the face within the visual content.

6. The image capture device of claim 1, wherein the rear display is deactivated during the presentation of the preview of the visual content on the front display.

7. The image capture device of claim 6, wherein the rear display is activated during non-presentation of the preview of the visual content on the front display.

8. (canceled)

9. (canceled)

10. The image capture device of claim 1, wherein the analysis of the visual content to determine whether the face is located within the center portion of the field of view of the optical element during the capture duration includes analysis of the visual content within a center portion of the visual content, the center portion of the visual content generated from light conveyed through the center portion of the field of view of the optical element.

11. A method for automatically controlling display operation, the method performed by an image capture device including one or more processors, a housing having multiple sides, the multiple sides including a front side and a rear side, an image sensor carried by the housing and configured to generate a visual output signal conveying visual information based on light that becomes incident thereon, the visual information defining visual content, an optical element carried on the front side of the housing, the optical element configured to guide light within a field of view to the image sensor, a front display carried on the front side of the housing, and a rear display carried on the rear side of the housing, the method comprising:
capturing, by the one or more processors, the visual content during a capture duration, the visual content captured through the optical element;
presenting, by the one or more processors, a preview of the visual content on the rear display;
determining, by the one or more processors, whether a face is located within a center portion of the field of view of the optical element during the capture duration based on analysis of the visual content, the center portion of the field of view being smaller than the field of view;
responsive to the face being located within the center portion of the field of view of the optical element and the front display not presenting the preview of the visual content, switching, by the one or more processors, the presentation of the preview of the visual content from being presented on the rear display to being presented on the front display; and
responsive to the face not being located within the center portion of the field of view of the optical element and the front display presenting the preview of the visual content, switching, by the one or more processors, the presentation of the preview of the visual content from being presented on the front display to being presented on the rear display.

12. The method of claim 11, further comprising determining whether the face is located within a target distance of the optical element during the capture duration, further wherein the switch in the presentation of the preview of the visual content from being presented on the rear display to being presented on the front display is conditioned on the face being located with the target distance of the optical element.

13. (canceled)

14. (canceled)

15. The method of claim 12, wherein a distance between the face and the optical element is determined based on size of the face within the visual content.

16. The method of claim 11, wherein the rear display is deactivated during the presentation of the preview of the visual content on the front display.

17. The method of claim 16, wherein the rear display is activated during non-presentation of the preview of the visual content on the front display.

18. (canceled)

19. (canceled)

20. The method of claim 11, wherein the analysis of the visual content to determine whether the face is located within the center portion of the field of view of the optical element during the capture duration includes analysis of the visual content within a center portion of the visual content, the center portion of the visual content generated from light conveyed through the center portion of the field of view of the optical element.

21. (canceled)

22. (canceled)

23. (canceled)

24. (canceled)

25. The image capture device of claim 1, wherein the switch in the presentation of the preview of the visual content from being presented on the front display to being presented on the rear display responsive to the face not being located within the center portion of the field of view of the optical element and the front display presenting the preview of the visual content includes the front display being turned off.

26. The image capture device of claim 1, wherein the switch in the presentation of the preview of the visual content from being presented on the front display to being presented on the rear display responsive to the face not being located within the center portion of the field of view of the optical element and the front display presenting the preview of the visual content includes information being presented on the front display changing from the preview of the visual content to setting of the image capture device.

27. The image capture device of claim 10, wherein the analysis of the visual content to determine whether the face is located within the center portion of the field of view of the optical element during the capture duration does not include analysis of the visual content outside the center portion of the visual content.

28. The image capture device of claim 10, wherein the analysis of the visual content to determine whether the face is located within the center portion of the field of view of the optical element during the capture duration includes application of a mask to the visual content to select the center portion of the visual content for analysis.

29. The method of claim 11, wherein the switch in the presentation of the preview of the visual content from being presented on the front display to being presented on the rear display responsive to the face not being located within the center portion of the field of view of the optical element and the front display presenting the preview of the visual content includes the front display being turned off.

30. The method of claim 11, wherein the switch in the presentation of the preview of the visual content from being presented on the front display to being presented on the rear display responsive to the face not being located within the center portion of the field of view of the optical element and the front display presenting the preview of the visual content includes information being presented on the front display changing from the preview of the visual content to setting of the image capture device.

31. The method of claim 20, wherein the analysis of the visual content to determine whether the face is located within the center portion of the field of view of the optical element during the capture duration does not include analysis of the visual content outside the center portion of the visual content.

32. The method of claim 20, wherein the analysis of the visual content to determine whether the face is located within the center portion of the field of view of the optical element during the capture duration includes application of a mask to the visual content to select the center portion of the visual content for analysis.
